(19) United States
(12) Patent Application Publication
(10) Pub. No.: US 2005/0091073 A1
(43) Pub. Date: Apr. 28, 2005

(54) System and method for erasing a hard drive via a computer network

(75) Inventor: David Harris, Poughquag, NY (US)

Correspondence Address: Robert G. Lancaster;Bryan Cave, LLP, Suite 3400, One Metropolitan Square, St. Louis, MI, 63102, US

(73) Assignee: Windsortech, Inc., Hightstown, NJ (US)

(21) Appl. No.: 10/694,156

(22) Filed: Oct. 27, 2003

(51) Int. Cl. G06F 17/60

(52) U.S. Cl. 705/1

(57) ABSTRACT

A system and method for delivery of complete hard drive erasing software to a client computer via Internet and Windows operating systems. Hard drive erasing software is installed into a software program which simulates the booting of a floppy disk, the integrated software is subsequently installed into a software installation program and is delivered to the customer computer over a computer network by a vendor server connected to the computer network (Internet). At the customer computer, the hard drive erasing software is executed on the customer computer hard drive by executing the boot simulation software.

### FIELD OF INVENTION

The present invention relates to a system and method for delivery of complete hard drive erasing software to a client computer via Internet and Windows operating systems. More specifically, the present invention relates to a system and method for utilizing hard drive erasing software over a computer network by simulating the booting of a floppy disk from within Windows.

### BACKGROUND ART

Prior art drive erasing software that operates from within Windows can only erase partitions on hard drive that Windows recognizes. Other prior art software that offers complete hard drive erasing capability requires booting from a floppy disk, which is not practical for a system intended for providing hard drive erasing software to a client computer via the Internet.

### SUMMARY OF THE INVENTION

The present invention provides a system and method for a customer to purchase the right to use hard drive erasing software over the Internet. After completing the purchase, the customer receives a proposed license agreement, and once accepted by the customer, the disk erasure software installation begins. The software is delivered and installed automatically by packaging the disk erasure software within an InstallShield software package.

InstallShield Express creates Windows Installer setups via an intuitive visual interface. Files can be added to the program by dragging and dropping them to the appropriate view.

Using the InstallShield software, customers can install applications directly from the Internet using One-Click Install Technology. Customers can download and install in one step and applications can be secured using password protection and digital signatures.

Upon completion of installation, the disk erasure software program is executed. The disk erasure software comprises a complete hard drive erasing program, such as PowerQuest DataGone, and a program to simulate the booting of a floppy disk from within Windows, such as PowerQuest's Virtual Floppy Technology. Using the simulation program, like Virtual Floppy Technology, allows DataGone to execute outside the Windows operating system, thus providing the capability to completely erase a hard drive.

This system and method provides an easy, fast and effective way for erasing hard disks, which meets US Department of Defense 5220.22-M, Chapter 8-306 sanitizing standards. The erasing software is a DOS-based software program which can remove sensitive information from a computer before the machine goes to a new or unprotected environment or to clear a hard disk of all programs and data before installing a new system. The software incorporates overwriting patterns which use up to 99 passes over hard disk sectors to ensure complete erasing of all sensitive data. All erasing proceedings and results can be verified and displayed to the customer.

In the preferred embodiment of the present invention, a floppy boot simulation program, such as PowerQuest Virtual Boot Environment (VBE) software, is used to allow non-Windows programs, such as a DOS-based disk erasure program like DataGone, to execute from off of the hard drive on Windows operating systems, such as Windows 9x, Windows Me, Windows NT, Windows 2000, Windows XP, and Linux platforms, as if they were running from a boot floppy disk or from a bootable CD. In this approach, the disk erasure software can be delivered to and operated upon the customer's computer from the Internet without the need to physically transfer and manually install a boot floppy disk or bootable CD. In this manner, the unauthorized copying and/or dissemination of the software is prevented, because the customer never obtains direct access to the programs.

In the preferred embodiment of the invention, disk erasure software can be downloaded from the remote vendor computer and installed immediately on the customer's computer. In the invention, the system allows a customer to purchase the available computer software electronically. The customer, for example, provides credit card information, debit card information, an account number to bill, etc. to the vendor computer. Secure transaction technology and/or digital signatures are used to safeguard the payment information. After verifying the payment information, the vendor computer permits transfer of the disk erasure software.

The disk erasure computer software is automatically installed on the user computer using the InstallShield program. Since it is not necessary for the user to install the computer software, the incidence of user related installation problems is greatly reduced. Also, it is not necessary for the user to obtain or save any storage media, since the computer software is downloaded directly to the user computer.

The foregoing and other features and advantages of the illustrated embodiment of the present invention will be more readily apparent from the following detailed description, which proceeds with reference to the accompanying drawings.

### BRIEF DESCRIPTION OF THE DRAWINGS

FIG. 1 is a block diagram of a computer network system showing the vendor server and the remote customer computers used to implement an illustrated embodiment of the present invention.

FIG. 2 is a flow chart showing the access processes on the user and vendor computers which are followed when a user orders disk erasure software services.

### DETAILED DESCRIPTION OF THE INVENTION

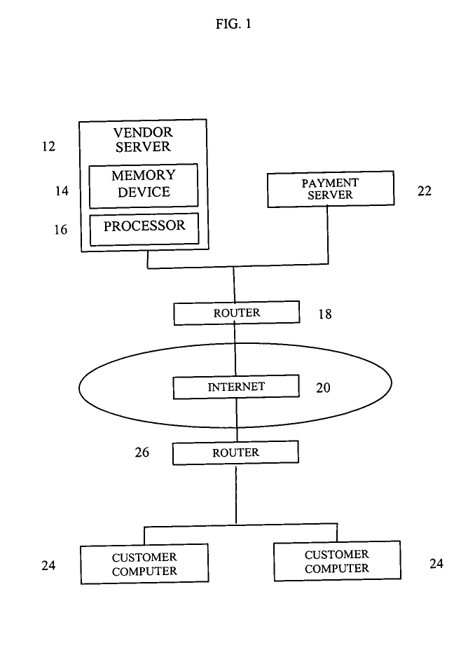

FIG. 1 depicts a system for automatically delivering disk erasure software services to a customer in accordance with the invention. A vendor server 12 includes a memory device 14 and a computer processor 16. The memory device 14 is used to store electronic data, such as credit card authorization software program, the hard drive erasing program, the software program simulating the booting of a floppy disk and the software installation program. The vendor server 12 is connected via a network with a router 18 to the Internet 20. A payment server 22 is also connected via the network with the vendor server 12 and the router 18 to the Internet 20. The customer computer 24 is connected by a network with a router 26 to the Internet 20.

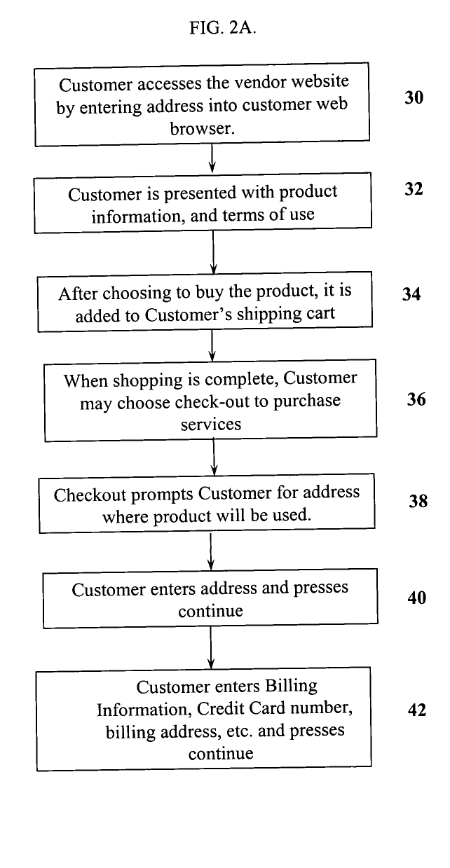

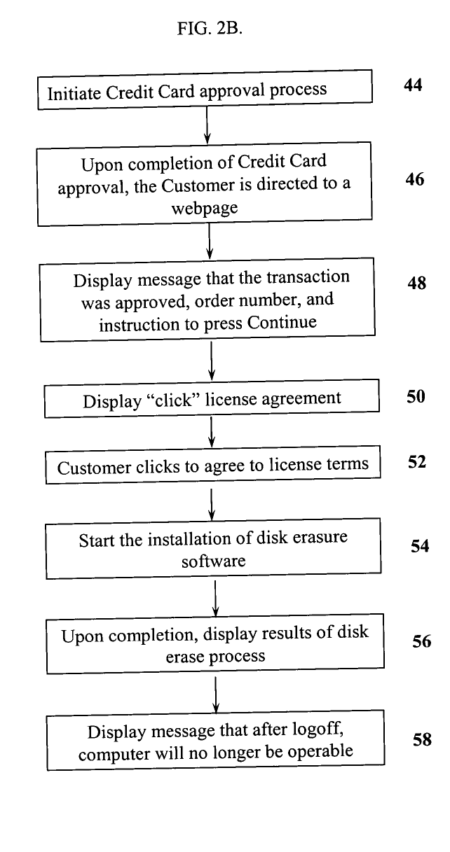

FIG. 2 depicts the steps in a method for automatically delivering disk erasure software services to a customer in accordance with the invention. As shown in FIG. 2, initially, at step 30, a consumer accesses the vendor website by entering the vendor website address into the web browser on the customer computer. Upon accessing the vendor website (step 32), the customer will be presented with information regarding the potential disadvantages of disposition of a prior computer without erasure of the hard disk. The customer is also be presented with a button menu display of available products, along with associated information for each product. After selecting to buy the product (step 34), it is added to the customer's “shopping cart” account record. When shopping is complete (step 36), the customer may elect to pay for the selected services by selecting the “check-out” menu button.

In the checkout process (step 38), the vendor computer initiates a display which prompts the customer to enter the address where product will be used. After entering the address (step 40), the customer is instructed to press the “continue” menu button, and to enter information required for the payment authorization program, including billing information, such as credit card type and account number, billing name and address, etc.

After completing this billing data form (step 42),the customer is instructed to press continue. This operation initiates the credit card approval process (step 44). Upon successful completion of the credit card approval, the customer is directed to a web page (step 46). The webpage displays a message notifying the customer that the transaction was approved, providing order number, and instructing the customer to press continue (step 48). Next, a “click” license agreement is displayed (step 50). Once the customer “clicks” the “AGREE” button to signify acceptance of the license terms at step 52, the software installation program is initiated to start the installation and execution of the disk erasure software (step 54).

Upon completion of the disk erasure software execution (about 1-3 hours), the results of disk erase process are displayed on the customer's monitor (step 56), along with a message informing the customer that after logoff, due to the erasure of the operating system on the hard disk, the computer will no longer be operable (step 58).

Network Access

The structure of the publicly accessible Internet is generally known to be a global computer network that includes a large number of computer systems that are interconnected by a large number of communication links. Digital communications are serviced on the Internet according to the Internet Protocol/Transfer Control Protocol (TCP/IP) standards and other associated networking standards. Thus, communications across the Internet are substantially standardized to facilitate inter-computer communications. A presence on the Internet is often referred to as a “website” at which content (e.g., HTML files, audio files, video files, executable files, etc.) is accessible. A website may be a dedicated stand-alone “web-server” or may simply be an IP address serviced by a service provider. Users of the Internet often use a “browser” or other software to view content contained at websites. Such content is downloaded from the website to the user across the Internet infrastructure.

For the purposes of this document, a “network” is understood to be a plurality of interconnected, computer-controlled devices that are capable of cooperative interactions. In most networks (for example, the Internet), the networked devices are either clients (users of documents) or servers (providers of documents). In such a network architecture, a customer, using a client device, is able to download documents and have services performed remotely by sending appropriate messages to the particular “server(s)” that is(are) responsible for performing the service or storing the desired documents.

A user accesses documents stored on the WWW using a Web browser (a computer program designed to display HTML documents and communicate with Web servers) running on a Web client connected to the Internet. Typically, this is done by the user entering the URL of a desired document or selecting a hypertext link (displayed by the Web browser as a highlighted word or phrase) within a document being viewed with the Web browser. The Web browser then issues a HTTP (hypertext transfer protocol) request for the requested document to the Web server identified by the requested document's URL. In response, the designated Web server returns the requested document to the Web browser, also using the HTTP, and the Web browser displays the document locally, including any text and images associated with the document.

Loading And Running The Disk Erasure Program

The PowerQuest VBE operates by temporarily replacing the Master Boot Record (MBR) boot code on the primary hard drive. Upon rebooting the computer, the new boot code loads and runs the DataGone program stored in the VBE image file. This Virtual Boot Environment consists of a loader program, disk I/O redirector TSR program, and a non-compressed floppy boot image file. The boot image file contains both the bootable OS files and the DataGone user application program and data.

Upon booting, the VBE loader builds a RAM DRIVE in memory the size of the boot image file, copies the boot image file from the hard drive to memory and then loads and executes the boot sector within the boot image file. Under DOS, the A: drive is then used to reference the boot image file system just as when booting from a CD. The first physical floppy drive is accessed as drive letter B:.

The VBE software allows programs and data to be both read and written to the VBE A:drive. However, upon completion of the disk erasure program operation, any changes written to the A:drive will be lost when the computer is rebooted or the power is cycled, just as when using a standard RAM DRIVE. Thus, the customer does not have any access to the erasure software after its execution is complete.

There are four main steps in the operation of Virtual Boot Environment.
1 Build the boot image file, PQVF.VFD to include the DataGone program.
2 Building the VBE directory on the hard drive.
3 Run the Virtual Boot Environment Enabler program.
4 Reboot the computer to execute the VBE loader.

Several VBE image files can be created and stored in the VBE directory with descriptive image filenames like w98boot.ima, w2kboot.ima, w95bboot.ima, etc. Batch files can then be created that will copy or rename each image file to PQVF.VFD before executing the VBE installer. Under a GUI environment, icons can be created that will boot to the image needed with just a click of the mouse.

The VBE image file is a raw sector-by-sector representation of a floppy file system in either a 1.44 MB or a 2.88 MB floppy disk format. The VBE image file contains everything that would exist on a bootable floppy disk, such as boot sector, FATs, directories, and files.

The boot image file is built using the VFILE program to create and manage the bootable floppy image file directly on the computer's hard disk without first creating a physical floppy disk.

VFILEX is a DOS command line program in VBE that enables creation and management of floppy image files.

The following steps are used to build the VBE directory:
1. Create a subdirectory on the primary boot drive of the computer to contain all the VBE files.
2. Copy the required VBE files VFLOPPY.SYS, VFLOPPYLD.SYS, VFRSTMBR.COM, RESTRMBR.EXE, and REBOOT.COM to the new subdirectory.
3. Copy the appropriate VBE installer files for the operating system that will be running when the VBE enabler program will be executed.
4. Name the virtual floppy image file PQVF.VFD, and copy it into the newly-created subdirectory.

With these files present in the subdirectory, instructions can be given to run the enabler program, reboot the computer and run the VBE to execute the DataGone program stored within the virtual floppy image.

VBE Enabler Program

The VBE enabler program prepares the computer to boot to the VBE during the next computer boot up sequence. There are four versions of the VBE enabler program used for the associated operating systems:
VFINSTNT.EXE—Windows NT, Windows 2000, and Windows XP.
VFINST9X.EXE—Windows 9x, Windows Me.
VFINSTD.EXE—DOS
vfinstlx—Linux

The VBE installer saves the current MBR to a backup file (MBR.DAT), writes the new MBR boot code to sector 1 and to two other sectors on track one of the hard drive, records in the VBE loader the physical disk location of the VBE image file, PQVF.VFD, located in the current directory, and then reboots the computer.

Running the Virtual Boot Environment

When the VBE loader has been enabled, the next time the computer is booted the VBE loader receives control, loads the PQVR.VFD file, and executes the boot programs contained in the floppy image. During the loading process the following characters are displayed on the screen to indicate the loader's progress.
   | . . .
Msg 11 Loading Virtual Floppy
Msg 12 Virtual Floppy Loaded
   At this point the virtual floppy, which at this point has been loaded into memory, runs and display a DOS load message like “Starting DataGone”.

Upon a successful boot, the VBE loader restores the original MBR back to sector 1 unless the /AUTORMV=OFF switch was specified when the VBE installer was run. This will cause the normal hard drive boot sequence to be activated the next time the computer is booted.

Although the VBE software provides the capability for restoring the original boot sequence, this function is not used, because this file is erased with the hard drive.

Disk Erasure Software Operation

PowerQuest® DataGone is a DOS-based software program which can be executed as follows:
1. run xetup.exe from the PowerQuest CD
   A serial number is used to control access to the software serial numbers for multiple uses. DataGone is executed by a DOS prompt outside of Windows and cannot be operated from a console window, such as MS-DOS Prompt on the Windows Start menu.
2. restart the computer in MS DOS mode
   The software option to erase the Entire Disk is selected. Using the DoD-approved erasure method, the software writes a random value, then its complement, then a different random value to each byte on the drive.

These software options are preferably predetermined via command line switches. Options to erase all hard drives, to perform a DoD-approved erasure process and to log the results to the virtual floppy for viewing by the customer are preferably selected.

Boot Record

In order for electronic devices such as client digital computers which include one or more processors that utilize programs stored in memory to commence operation, it is necessary upon initial power-up to automatically load sufficient instructions to enable the device to perform basic input and output tasks, and locate and load the remainder of its operating system. These relatively minimal instructions are commonly referred to with a variety of names, such as the boot program, boot loader or flash kernel. The boot program must be stored in nonvolatile memory, such as a read only memory (hereinafter, “boot ROM”), in a block (often called the “boot record”) beginning at a preselected address so that upon initial power-up hardware circuitry can locate and load the boot program for processor execution. Boot ROM may be any nonvolatile memory suitable for storage of the boot record. As is well known to the ordinarily skilled artisan, output of the boot record from the boot ROM to the customer computer's operating memory is accomplished by selective and appropriate application of signals of the necessary logic level to the chip select (“CS”) and output enable (“OE”) inputs to the boot ROM memory.

The following shows a sample command file for booting of DataGone software: Autoexec.bat
DG -d* -M4V -T -Y -K -L
   Payment Authorization

Preferably, software executing on the vendor computer 12 automatically receives the customer data and performs the functions of receiving payment for the services by executing a commercially available payment authorization software program, such as GO Software's PCCharge Virtual Terminal™, which enables processing of credit card transactions from the vendor computer through an Internet connection and a Web browser.

PCCharge Payment Server™ is an open architecture credit card software product designed to integrate the payment processing function into internet-based transaction software. To authorize credit card transactions, the vendor software inputs the credit card data obtained from the customer into the PCCharge Virtual Terminal software. This information is encrypted using Secure Socket Layer (SSL) technology and sent to PCCharge Payment Server on the vendor website. The server then sends the data through the authorization network to the appropriate card issuer's bank over a secure Internet connection or through a dial up connection. When the authorization process is complete, an authorization number is received by the vendor software, and the PCCharge Payment Server stores the transaction information. The receipt of the authorization number by the vendor software triggers the delivery of messages to the customer display and allows the expedition of the disk erasure software to commence.

The present invention encompasses a system and method for erasing the hard drive of a customer computer which is connected to a computer network, comprising providing a vendor server connected to the computer network,installing hard drive erasing software into a software program which simulates the booting of a floppy disk, installing the boot simulation software into a software installation program, delivering the software installation program to the customer computer over the computer network using the vendor server, and executing the hard drive erasing software on the customer computer by executing the boot simulation software.

The present invention also encompasses a system for erasing the hard drive of a customer computer which is connected to a computer network comprising a vendor server connected to the computer network having a memory device and processing means, hard drive erasing software stored in the memory device of the vendor server, a software program which simulates the booting of a floppy disk stored in the memory, where the processing means is programmed to deliver, install and execute the boot simulation software and hard drive erasing software into the customer computer over the computer network. The present invention further encompasses a system having credit card authorization software program stored in the memory device of the vendor server and processing means programmed to receiving credit card information from the customer computer over the computer network and to receive authorization of the credit card information by using the credit card authorization software program.

1. A method for erasing the hard drive of a customer computer which is connected to a computer network, comprising the steps of:
providing a vendor server connected to the computer network;
installing hard drive erasing software into a software program which simulates the booting of a floppy disk;
installing the boot simulation software into a software installation program;
delivering the software installation program to the customer computer over the computer network using the vendor server; and
executing the hard drive erasing software on the customer computer by executing the boot simulation software.

2. The method of claim 1 wherein the computer network is the Internet.

3. The method of claim 1 further comprising the step of receiving credit card information from the customer computer over the computer network.

4. The method of claim 2 further comprising the step of receiving authorization of the credit card information by using a credit card authorization software program.

5. The method of claim 1 wherein the hard drive erasing program is a DOS-based software program.

6. The method of claim 1 wherein the software program simulating the booting of a floppy disk is PowerQuest Virtual Floppy Technology.

7. The method of claim 1 wherein the hard drive erasing software program meets US Department of Defense 5220.22-M, Chapter 8-306 sanitizing standards.

8. The method of claim 1 further comprising the step of displaying the results of the hard drive erasing program on the customer computer.

9. The method of claim 1 wherein the hard drive erasing program is PowerQuest DataGone.

10. A system for erasing the hard drive of a customer computer which is connected to a computer network, the system comprising:
a vendor server connected to the computer network, the vendor server having a memory device and processing means;
hard drive erasing software stored in the memory device of the vendor server;
a software program which simulates the booting of a floppy disk stored in the memory device of the vendor server;
wherein the processing means is programmed to deliver, install and execute the boot simulation software and hard drive erasing software into the customer computer over the computer network.

11. The system of claim 10 further comprising credit card authorization software program stored in the memory device of the vendor server and wherein the processing means is programmed to receiving credit card information from the customer computer over the computer network.

12. The system of claim 11 wherein the processing means is programmed to receive authorization of the credit card information by using the credit card authorization software program.

13. The system of claim 10 wherein the processing means is programmed to deliver, install and execute the boot simulation software and hard drive erasing software using a software installation program.

14. The system of claim 10 wherein the computer network is the Internet.

15. The system of claim 10 wherein the hard drive erasing program is a DOS-based software program.

16. The system of claim 10 wherein the software program simulating the booting of a floppy disk is PowerQuest Virtual Floppy Technology.

17. The system of claim 10 wherein the hard drive erasing software program meets US Department of Defense 5220.22-M, Chapter 8-306 sanitizing standards.

18. The system of claim 10 wherein the hard drive erasing software program is configured to display the results of the hard drive erasing operation on the customer computer.

19. The system of claim 10 wherein the hard drive erasing program is PowerQuest DataGone.
